(19) United States
(12) Patent Application Publication
(10) Pub. No.: US 2026/0280204 A1
(43) Pub. Date: Sep. 17, 2026

(54) CONNECTOR HOUSING, HOUSING ASSEMBLY AND PLUG CONNECTION

(71) Applicant: TE Connectivity Solutions GmbH, Schaffhausen (CH)

(72) Inventor: Olivier DE CLOET, Bensheim (DE)

(21) Appl. No.: 19/563,194

(22) Filed: Mar. 11, 2026

(30) Foreign Application Priority Data
Mar. 14, 2025 (DE) 102025109930.8

(51) Int. Cl. H01R 24/84

(52) U.S. Cl. CPC H01R 24/84

(57) ABSTRACT

A hermaphroditically configured connector housing for a plug connection is configured to be pluggable along a plugging direction with a mating housing that is structurally identical to the connector housing and has a cable side and a plugging side, wherein the plugging side includes at least one positive-fit element extending transverse to the plugging direction and at least one receiving region that is configured to be complementary at least in sections to the at least one positive-fit element. The receiving region of the connector housing is provided for the positive-fit element of the structurally identical mating housing having a structurally identical receiving region for the positive-fit element of the connector housing. A housing assembly with such a connector housing may be provided. A plug connection with the housing assembly may be provided.

### CROSS REFERENCE TO RELATED APPLICATIONS

This application claims the benefit of DE Application No. 102025109930.8, filed 14 Mar. 2025, the subject matter of which is herein incorporated by reference in its entirety.

### BACKGROUND OF THE INVENTION

The subject matter herein relates to a connector housing for a plug connection, for example, but not exclusively to an electrical plug connection for use in the automotive sector. Furthermore, the subject matter herein relates to a housing assembly with such a connector housing. Moreover, the subject matter herein relates to a plug connection with a housing assembly.

In many technical applications, such as in automotive technology, cable-based plug connections are used for transmitting electrical currents and signals. Conventionally, one male and one female component (for example a plug and a socket) form the plug connection. The difference between these components must be considered during their installation and often leads to plugs and sockets having to be stocked in equal numbers. A further level of complexity arises for the plug connections regarding their cables, which at their ends can either be equipped with one plug and one socket respectively or can have two plugs or two sockets. The selection of the appropriate cable must then be made depending on the application.

In order to be able to represent all these variations, considerable effort must be expended in the manufacture, storage and installation of plug connections.

There is a need for creating options with which the manufacturability and applicability of plug connections may be generally improved.

### BRIEF DESCRIPTION OF THE INVENTION

In one embodiment, a connector housing is provided configured to be pluggable along a plugging direction with a mating housing that is configured to be structurally identical to the connector housing, wherein the connector housing has a cable-side and a plugging side, wherein the plugging side has at least one positive-fit element extending transverse to the plugging direction and at least one receiving region, that is configured at least in sections to be complementary to the at least one positive-fit element.

The connector housing is identical to the associated mating housing or at least of the same structural configuration or configured to be identical with respect to its dimensioning like the associated mating housing. In particular, the mating housing has a structurally identical plugging side (including its own positive-fit element and receiving region) which fits together with the plugging side of the connector housing, whereby mutual pluggability arises.

The receiving region of the connector housing is consequently provided for the positive-fit element of the mating housing. The plugged state is secured due to an interlocking of the positive-fit element of the connector housing with the receiving region of the mating housing (and vice versa) and a relative motion between the connector housing and the mating housing in the plugging direction is prevented.

In order to release or unlock the plugged state, the interlocking of the positive-fit element of the connector housing with the receiving region of the mating housing and the interlocking of the positive-fit element of the mating housing with the receiving region of the connector housing must first be released. A plug connection that uses the connector housing according to the invention is therefore reliable and easy to use due to this double securing option.

Although the receiving region of the connector housing is not provided for the positive-fit element of the connector housing (but rather of the mating housing), the shape of the positive-fit element of the connector housing nevertheless has a transitive effect on the receiving region of the connector housing. In other words, the receiving region on the connector housing must be complementary to its own positive-fit element so that it is able to accommodate the structurally identical positive-fit element of the mating housing at all. The receiving region configured to be complementary to the positive-fit element therefore forms a counterpart of the positive-fit element.

A further advantage of the connector housing according to the invention lies in the hermaphroditic configuration which is realized in particular due to the pluggability of the two structurally identical housings and with the aid of the complementarity between the positive-fit element and the receiving region.

No distinction must then be made between a plug housing and a socket housing, as is the case with conventional plug connections. Instead, the connector housing can be used on both sides of the plug connection, which simplifies both the manufacture and the handling of the entire plug connection.

A housing assembly which comprises the connector housing according to the invention and the mating housing that is structurally identical thereto also achieves the object set out at the outset. The plugging side of the connector housing and the plugging side of the mating housing can there be plugged together.

The advantages of the connector housing have a positive effect on the housing assembly. In addition, compared to conventional housing assemblies consisting of the plug housing and socket housing, two structurally identical components (i.e., connector housing and mating housing) can be used, whereby the range of required component types can be reduced by up to one half. This reduces manufacturing costs, since the connector housing and the mating housing can be manufactured with the same production device (for example, injection mold).

The object set out at the outset is further satisfied by a plug connection with a housing assembly according to the invention and at least one pair of contacts. In this, a first contact of the pair of contacts can be held in the connector housing and a second contact of the pair of contacts can be held in the mating housing. In the plugged state of the housing assembly, the contacts of the pair of contacts can mutually contact one another, so that electrical currents and signals are transmissible.

The plug connection according to the invention benefits from the advantages already mentioned above. Especially when a hermaphroditic pair of contacts is also used, this can facilitate the manufacture and assembly of the plug connection, since no distinction must be made as to which contact of the hermaphroditic pair of contacts belongs into which housing.

A connector consisting of a single connector housing according to the invention and at least one contact held therein also satisfies the object set out at the outset, since the advantages of the connector housing also come into play there.

In addition to electrical contacts, the pair of contacts of the plug connection or the contact of the connector can also be optical contacts, optical fiber contacts or fiber end faces. Mainly electrical configurations shall be discussed primarily hereafter. However, embodiments with optical conductors should not be excluded and are expressly covered by the present invention. Accordingly, the plug connection can be a purely electrical plug connection, a purely optical plug connection, an electrooptical plug connection or an optoelectronic plug connection.

The invention can be further improved by the following configurations which are advantageous by themselves and which may be combined with one another at random. The configurations described below relate equally to the connector housing and to the mating housing that is structurally identical thereto.

According to a first possible configuration, the at least one receiving region can form, at least in sections, a negative form of the at least one positive-fit element. This allows the complementarity between the positive-fit element and the receiving region to be easily implemented. The negative form is then an inverse form in which the receiving region captures projections or protrusions of the positive-fit element as recesses and recesses of the positive-fit element as projections or protrusions.

In particular, the negative form can be mirrored at a mirror plane relative to the actual positive-fit element. Alternatively or additionally, the negative form can be rotated in a rotation plane relative to the actual positive-fit element. The mirror plane and/or the rotation plane can there each run transverse to the plugging direction, in particular perpendicular to the plugging direction. In other words, the positive-fit element and its receiving region forming the negative form can be mirror-inverted and/or rotated relative to one another. Correspondingly, the connector housing can then be pluggable with the structurally identical mating housing when connector housing and the mating housing are oriented in a mirror-inverted manner and/or rotated relative to one another.

According to a further configuration, the at least one receiving region can be located between the cable-side and the at least one positive-fit element, in particular in the plugging direction between the cable-side and the at least one positive-fit element.

From the perspective of the mating housing, the receiving region of the connector housing is therefore disposed behind the positive-fit element of the connector housing. Consequently, the connector housing and the mating housing must be interlocked deeply so that their respective positive-fit elements and receiving regions can come into engagement, whereby the plugged or connected state is reliably secured.

Optionally, the at least one receiving region can be defined at least in sections by an abutment surface pointing toward the cable-side. The abutment surface can be spanned transverse to the plugging direction, in particular perpendicular to the plugging direction.

The positive-fit element of the mating housing coming from the plugging side can abut in a positive fit manner against this abutment surface, whereby a relative motion between the connector housing and the mating housing in the plugging direction is prevented and consequently their plugged state is secured. To release or unlock the plugged state, the positive-fit element of the mating housing can then be raised from the abutment surface of the connector housing and, vice versa, the positive-fit element of the connector housing can also be raised from the abutment surface of the mating housing.

According to a further possible configuration, the at least one positive-fit element can delimit the at least one receiving region at least in sections. This configuration is particularly advantageous since the plugged housing assembly can be unlocked by moving a single positive-fit element out from the associated receiving region. If, for example, the positive-fit element of the connector housing is moved out, it leaves the associated receiving region of the mating housing. Simultaneously, the limitation of the receiving region of the connector housing is released, so that the positive-fit element of the mating housing can also leave the associated receiving region of the connector housing.

The previously described abutment surface can be disposed on the at least one positive-fit element. If the positive-fit element of the connector housing in this configuration is moved, it lifts off from the abutment surface of the mating housing. At the same time, the abutment surface of the connector housing also lifts off from the positive-fit element of the mating housing without the positive-fit element of the mating housing having to be moved. This configuration also facilitates the unlocking and release of the plugged housing assembly.

The above configuration, in which the positive-fit element delimits the receiving region, can be easily implemented in that the at least one positive-fit element of the connector housing is in alignment at least in sections with the at least one receiving region of the connector housing, in particular in alignment in the plugging direction. In other words, the at least one positive-fit element and the at least one receiving region in the connector housing can overlap in the plugging direction.

Alternatively, the at least one positive-fit element and the at least one receiving region can be offset from one another, for example, in that an angular offset is present therebetween. Consequently, a mutual obstruction of the at least one positive-fit element and the at least one receiving region when being plugged together can be avoided.

Optionally, the at least one positive-fit element can be arranged on a deflectable snap arm. For example, the snap arm can be resiliently deflectable transverse to the plugging direction, in particular perpendicular to the plugging direction. The snap arm can also be held to be pivotable by way of a hinge. This simplifies the process of plugging together. In particular, the connector housing can have at least one insertion chamfer by which the snap arm of the structurally identical mating housing is automatically deflected or pivoted when during the plugging process.

According to a further possible configuration, the at least one receiving region can form an undercut for the at least one positive-fit element of the mating housing. In particular, the undercut can be present as viewed in the plugging direction, so that a motion of the mating housing in the plugging direction is prevented when the positive-fit element of the mating housing engages in the undercut of the connector housing. With this configuration, the plugged state can be easily established and reliably secured.

To simplify handling, the connector housing can comprise at least one rocker having a first lever arm extending away from the cable-side and a second lever arm extending toward the cable-side. Disposed between the first and the second lever arm of the rocker can be a notional axis of rotation about which the two lever arms are pivotable.

The at least one positive-fit element can there be arranged on the first lever arm of the rocker. For example, the abovementioned snap arm can form the first lever arm of the rocker. An actuating element can be disposed on the second lever arm of the rocker. The positive-fit element and the actuating element are then connected by way of the rocker in a manner transmitting motion. Firstly, this allows for the exploitation of a lever effect. Secondly, the actuating element can have better accessibility on the cable-side than the positive-fit element on the plugging side.

The actuating element can be, for example, a pressure region. The actuation of the pressure region leads to, for example, the second lever arm being lowered and the first lever arm being raised. The positive-fit element can therefore be moved out of its engagement with the receiving region of the mating housing. As already described above, this moving out then enables a separation of the connector housing and the mating housing.

In addition to unlocking, the actuating element can also aid in plugging together the connector housing and the mating housing. Because the lowering of the second lever arm while simultaneously raising the first lever arm allows for the positive-fit element of the connector housing to move past the receiving region of the mating housing in an unobstructed manner. When the housing assembly is plugged together completely, the actuating element can be released, whereby the positive-fit element of the connector housing sinks into the associated receiving region of the mating housing and henceforth secures the plugged state.

As shall be explained in more detail below, it can be advantageous to have the first lever arm and the second lever arm of the rocker be located at least in sections at different heights or levels. In particular in the force-free state of the rocker, the first lever arm and the second lever arm can be arranged at different heights or levels. The different heights can be measured perpendicular to the plugging direction.

For example, the at least one positive-fit element on the first lever arm can be disposed lower (i.e., closer to the remainder of the connector housing) than the second lever arm with the actuating element. In particular, the first lever arm can be disposed below the axis of rotation already mentioned, while the second lever arm is above or at the same height as the axis of rotation. This height offset advantageously leads to the motion trajectory of the positive-fit element having a pulling component directed toward the cable-side, pulling the connector housing and its mating housing toward one another. Any dimensional tolerances and unwanted play between the connector housing and the mating housing can thus be minimized, if not completely eliminated.

The abovementioned first contact of the pair of contacts can be affixed in the connector housing by a terminal lock (TPA, terminal position assurance). For example, the terminal lock can be configured to be insertable into the connector housing laterally, in particular perpendicular to the plugging direction. In the inserted state, the terminal lock can be in positive-fit engagement with the first contact of the pair of contacts. Optionally, this terminal lock can also be used to prevent a deflection of the snap arm or rocker already mentioned.

In other words, the terminal lock can block the snap arm or rocker and in this way affix the at least one positive-fit element of the connector housing in the at least one receiving region of the mating housing. For this purpose, the terminal lock can comprise, for example, a blocking section that engages around the snap arm or the first lever arm of the rocker. Alternatively, the blocking section can also fill a gap between the second lever arm and the remainder of the connector housing and thus prevent the movability of the rocker. Accordingly, this configuration of the terminal lock prevents the unwanted release of the pair of contacts in two ways, by affixing the first contact of the pair of contacts and simultaneously restricting the movability of the at least one positive-fit element in order to prevent accidental separation of the plug connection.

According to a further possible configuration, the connector housing can comprise at least one coding projection and at least one coding groove. For example, the at least one coding projection can be disposed on the at least one positive-fit element and the at least one coding groove in the at least one receiving region. Of course, a reversed arrangement of the coding projection and the coding groove is also conceivable.

The structurally identical mating housing then also comprises at least one coding projection and at least one coding groove at corresponding positions. In the plugged state, the coding projection of the connector housing meets the coding groove of the mating housing and likewise the coding projection of the mating housing meets the coding groove of the connector housing. Despite the hermaphroditic configuration, a restriction can consequently nevertheless be imposed to avoid incorrect plugging of the connector housings and the mating housings that do not belong to one another.

Despite the hermaphroditic configuration of the connector housing and the structurally identical mating housing, they can also be used in conventional, non-hermaphroditic plug connections. This shall be explained in more detail below and has the advantage that backward compatibility arises between the connector housing according to the invention and already existing plug devices or interfaces.

In other words, the connector housing according to the invention can be configured to be connectable both with the structurally identical mating housing and with a structurally nonidentical mating housing. In particular, the connector housing can be configured to be configured to be connectable with a plug housing or a socket housing of any specified interface. This specified interface need not itself have a hermaphroditic configuration, so that neither the plug housing nor the socket housing of the specified interface is structurally identical to the connector housing. For example, the specified interface can be a customer-specified or manufacturer-specified interface or an interface of an already installed plug device. The specified interface is therefore subject to unchangeable design constraints which preclude its own hermaphroditic configuration and to which the connector housing can be adapted.

Above all, the backward compatibility with the socket housing of the specified interface is advantageous, since the latter is typically permanently installed in a vehicle component, while the corresponding plug housing of the specified interface is disposed on a cable or wire. Accordingly, already existing socket housings can often be replaced with greater difficulty or greater effort than already existing plug housings.

An adapter can be provided in order to achieve the backward compatibility just mentioned with the socket housing of the specified interface. The adapter can comprise an adapter inlet and an adapter outlet. The adapter inlet can be configured to receive the connector housing according to the invention at least in part, while the adapter outlet forms a connector face of the specified interface that is complementary to the socket housing. In other words, the adapter outlet can comprise an outer contour which corresponds to the plug housing of the specified interface.

The adapter can then serve as a connecting link between the connector housing according to the invention and the socket housing of the specified interface. Accordingly, such an adapter satisfies the object set out at the outset, since it extends the applicability of plug connections. An (assembly) kit with a housing assembly according to the invention, a socket housing of a specified interface, and such an adapter likewise satisfies the object set out at the outset. Here, the socket housing of the specified interface is precisely not structurally to be identical to the connector housing of the housing assembly. In other words, the (assembly) kit, in addition to the adapter, comprises a connector housing, a mating housing that is structurally identical thereto, and a socket housing of a specified interface structurally not identical thereto.

As an alternative to the adapter, the connector housing according to the invention itself can also comprise on its plugging side an outer contour which corresponds to the plug housing of the specified interface. In other words, the plugging side of the connector housing can form the connector face that is complementary to the socket housing. Consequently, an (assembly) kit with a housing assembly according to the invention and a socket housing of a specified interface also satisfies the object set out at the outset when the plugging side of the connector housing of the housing assembly forms the connector face of the specified interface that is complementary to the socket housing. The improved usability of the plug connection presently arises from the fact that the connector housing is compatible both with the mating housing of the housing assembly that is structurally identical thereto and with the socket housing of the specified interface that is structurally not identical thereto.

Increased stability of the plugged state arises when the plugging side has two positive-fit elements and two receiving regions. For example, the two positive-fit elements can be disposed opposite one another perpendicular to the plugging direction. Similarly, the two receiving regions can be disposed opposite one another perpendicular to the plugging direction. For each positive-fit element, its own insertion chamfer, rocker, coding groove or coding projection and/or snap arm can then be provided.

The two receiving regions can be disposed between the two positive-fit elements. Alternatively, the two positive-fit elements can be disposed between the two receiving regions. In both cases, a compact design of the connector housing results.

According to a further possible configuration, the two positive-fit elements can jointly delimit the two receiving regions. This achieves redundancy and increased safety. Should one of the positive-fit elements break off, the respective other positive-fit element still delimits the two receiving regions and prevents unintentional unlocking of the housing assembly.

The invention shall be described hereafter by way of example using embodiments with reference to the figures. In the drawings, the same reference characters are always used for elements which correspond to one another with regard to function and/or structure.

In accordance with the above description, a feature of an embodiment can be omitted if the technical effect associated with this feature is not important for a specific application. Conversely, a feature that is not yet present there can also be added to an embodiment in accordance with the above description if the technical effect of the feature to be added is important for a specific application.

### BRIEF DESCRIPTION OF THE DRAWINGS

FIG. 1 shows a schematic illustration of an exemplary embodiment of the connector housing;

FIG. 2 shows a schematic illustration of the connector housing from FIG. 1 in a side sectional view;

FIG. 3 shows a schematic detailed illustration of the connector housing from FIG. 1 in a side view;

FIG. 4 shows a schematic illustration of the connector housing from FIG. 1 in a front view;

FIG. 5 shows a schematic illustration of an exemplary embodiment of the housing assembly;

FIG. 6 shows a schematic illustration of an exemplary embodiment of the plug connection;

FIG. 7 shows a schematic illustration of a further embodiment of the housing assembly;

FIG. 8 shows a schematic illustration of a further embodiment of the housing assembly;

FIG. 9 shows a schematic illustration of the housing assembly from FIG. 8 in the plugged state;

FIG. 10 shows a schematic illustration of a further embodiment of the housing assembly;

FIG. 11 shows a schematic illustration of a further embodiment of the housing assembly;

FIG. 12 shows a schematic illustration of the housing assembly from FIG. 11 in the plugged state;

FIG. 13 shows a schematic illustration of an exemplary embodiment of the assembly kit;

FIG. 14 shows a schematic illustration of the assembly kit from FIG. 13;

FIG. 15 shows a schematic illustration of a further embodiment of the assembly kit;

FIG. 16 shows a schematic illustration of part of the assembly kit from FIG. 15;

FIG. 17 shows a schematic illustration of part of the assembly kit from FIG. 15;

FIG. 18 shows a schematic illustration of part of the assembly kit from FIG. 15;

FIG. 19 shows a schematic illustration of part of the assembly kit from FIG. 15;

FIG. 20 shows a schematic illustration of a further embodiment of the assembly kit;

FIG. 21 shows a schematic illustration of a further embodiment of the housing assembly;

FIG. 22 shows a schematic illustration of the housing assembly from FIG. 21;

FIG. 23 shows a schematic illustration of the housing assembly from FIG. 21; and

FIG. 24 shows a schematic illustration of the housing assembly from FIG. 21.

### DETAILED DESCRIPTION OF THE INVENTION

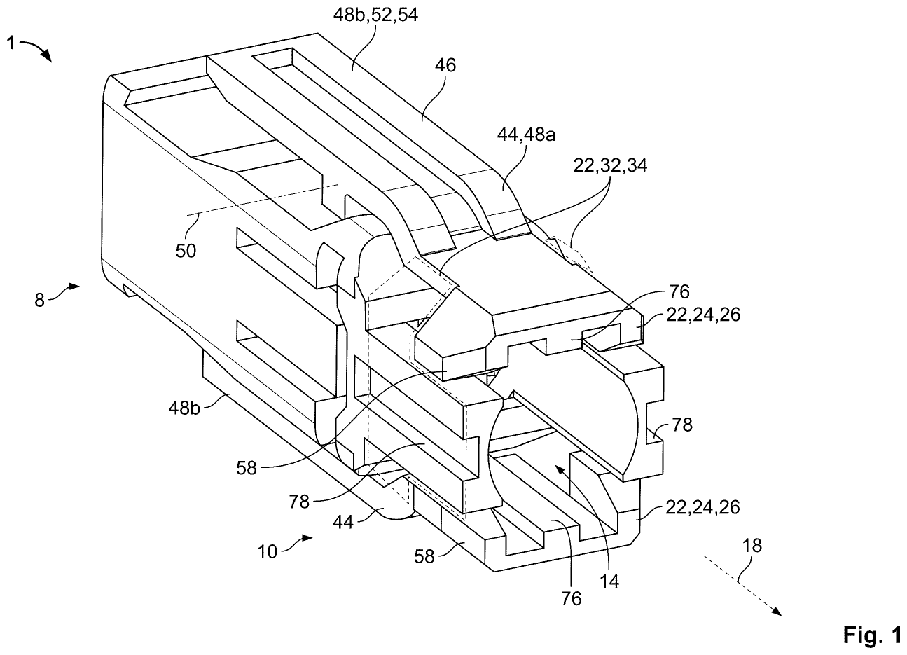

FIG. 1 shows a possible configuration of connector housing 1 in a perspective illustration. Connector housing 1 has a cable-side 8 and a plugging side 10.

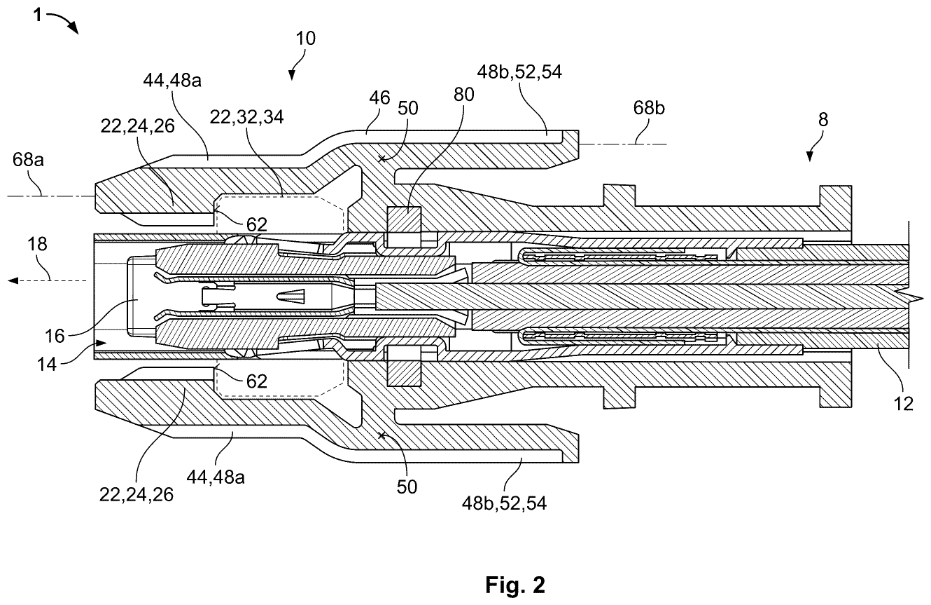

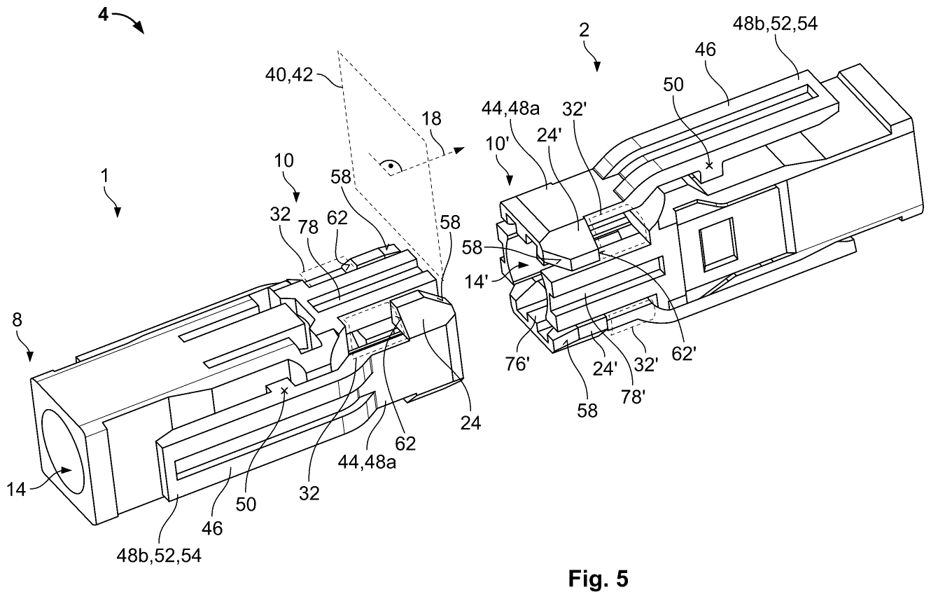

On cable-side 8, a cable 12 (see FIG. 2) can lead into a contact chamber 14 of connector housing 1. A contact 16 can be held in contact chamber 14. A mating contact (not shown) can be held in a mating housing 2 (see FIG. 5). Contact 16 and the mating contact can be electrical contacts, for example, shielded contacts and/or coaxial contacts for use in the automotive sector. Optical contacts, optical fiber contacts or fiber end faces can also be used as well.

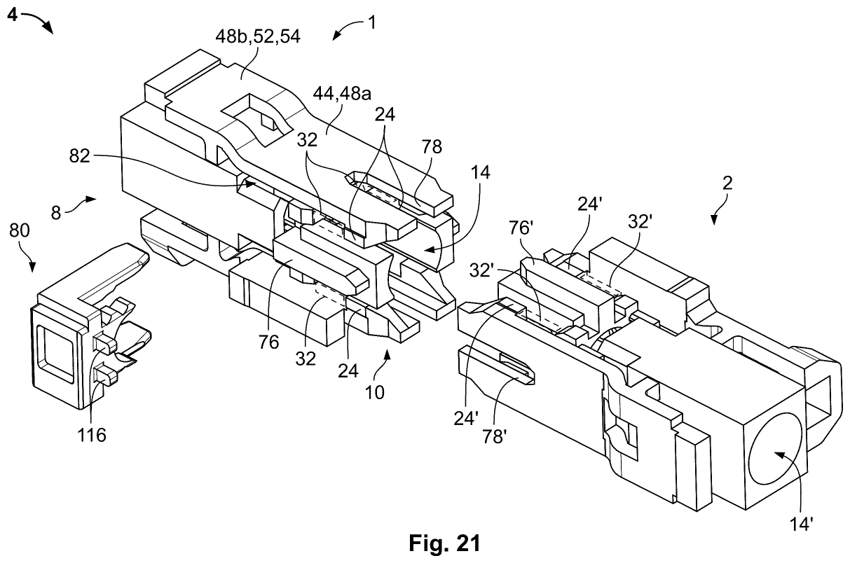

Contact 16 can be affixed in contact chamber 14 by a terminal lock 80. As is evident from the sectional illustration of FIG. 2, terminal lock 80 can be in positive-fit engagement with contact 16 for this purpose. For example, terminal lock 80 can be inserted laterally through an insertion slot 82 into connector housing 1 (see FIG. 21). Insertion slot 82 there extends to contact chamber 14 in the interior of connector housing 1. In a final position 84 of terminal lock 80, terminal lock 80 extends into contact chamber 14 and can interlock there with contact 16 in positive-fit manner.

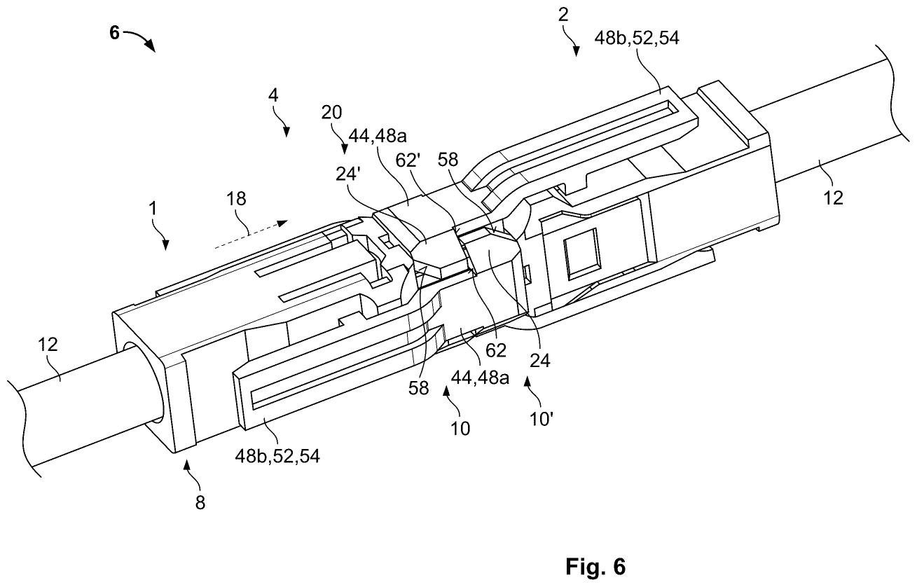

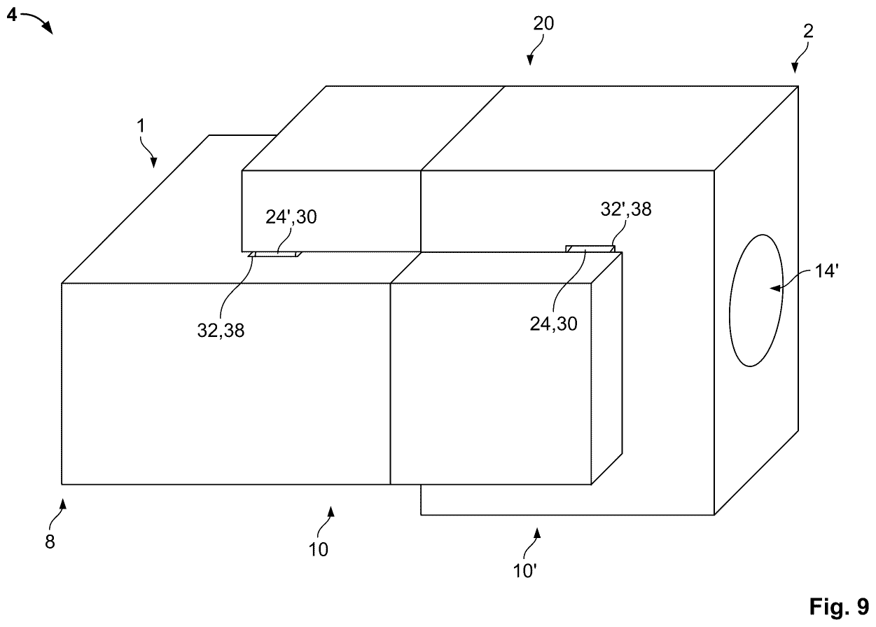

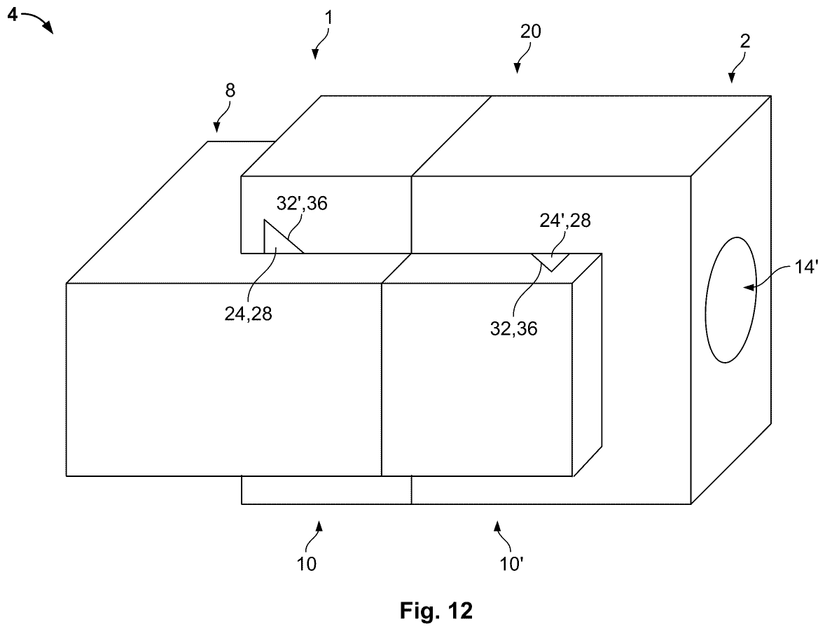

Connector housing 1 is configured hermaphroditically and is therefore pluggable along a plugging direction 18 with a mating housing 2 that is structurally identical to connector housing 1. Connector housing 1 and mating housing 2 there constitute a housing assembly 4 (see FIG. 5). Connector housing 1 and associated mating housing 2 are configured to be identical or at least of the same structural type or configured identically with respect to their dimensioning. In particular, mating housing 2 has a structurally identical plugging side 10′ which fits together with plugging side 10 of connector housing 1. In particular, plugging side 10 of connector housing 1 and plugging side 10′ of mating housing 2 can be plugged together. FIGS. 6, 9 and 12 each show this plugged state 20 between connector housing 1 and mating housing 2.

Therefore, the same housing component can be used twice, once as connector housing 1 and once as mating housing 2, without having to distinguish between a plug housing and a socket housing. Connector housing 1 and mating housing 2 can consequently be manufactured as injection-molded parts using the same injection mold.

In order to secure plugged state 20, connector housing 1 and mating housing 2 each have engagement members 22 on their plugging sides 10, 10′. The following description of engagement members 22 relates equally to connector housing 1 and to mating housing 2 that is structurally identical thereto.

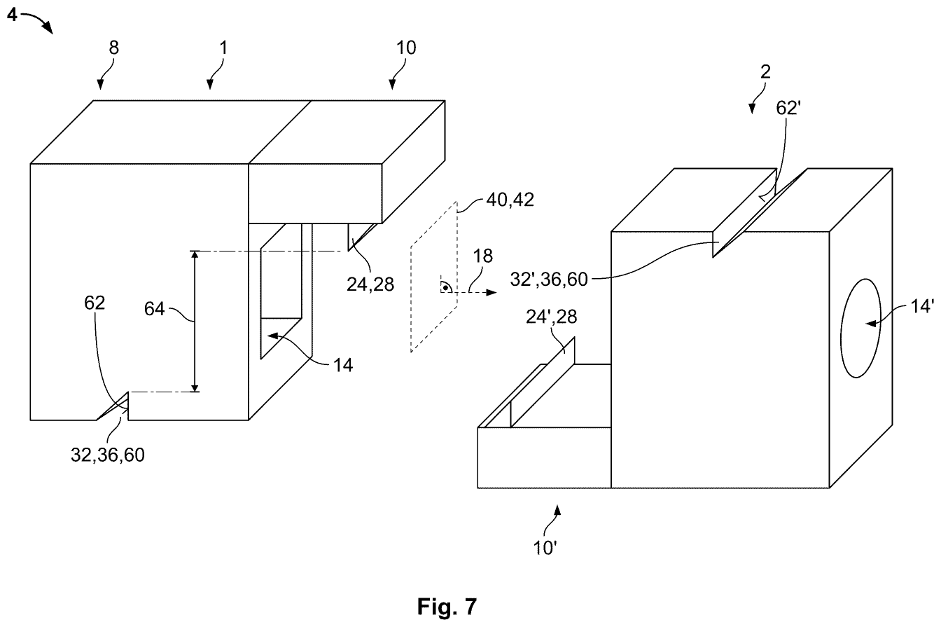

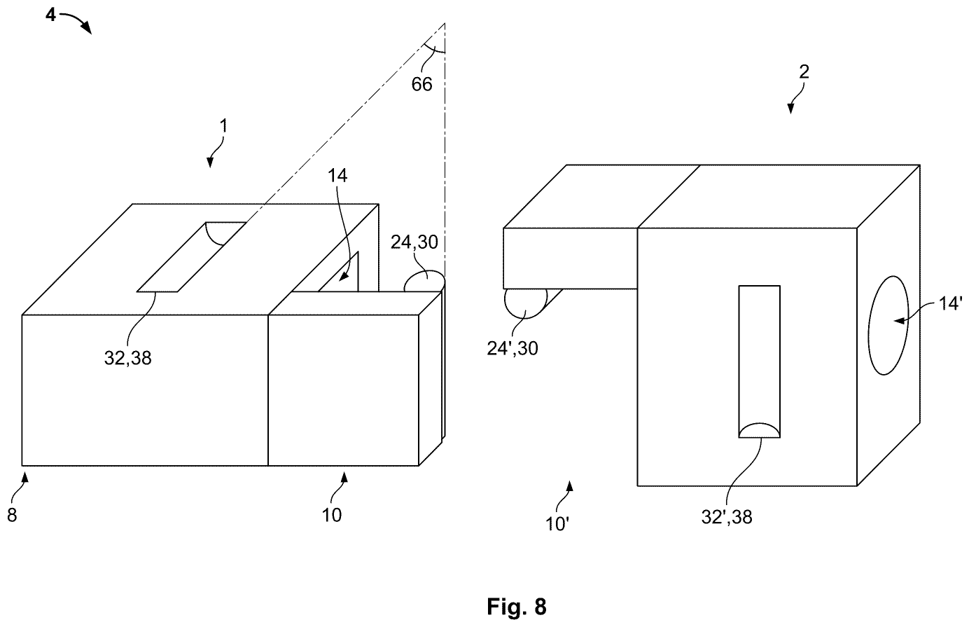

Plugging side 10 comprises at least one positive-fit element 24 extending transverse to plugging direction 18. In particular, positive-fit element 24 can extend perpendicular to plugging direction 18. In other words, positive-fit element 24 can project transverse, in particular perpendicular to plugging direction 18. For example, positive-fit element 24 can be configured as a hook 26 (see FIG. 2), prong 28 (see FIG. 7) and/or rib 30 (see FIG. 8). As shown in FIG. 1, two positive-fit elements 24 can be provided on plugging side 10. Two positive-fit elements 24 can be disposed opposite one another perpendicular to plugging direction 18. However, configurations with a single positive-fit element 24 for every connector housing 1 and mating housing 2 are also possible (see FIGS. 7 and 8).

Plugging side 10 also comprises at least one receiving region 32 which is configured to be complementary at least in sections to at least one positive-fit element 24. Its own receiving region 32 can be present for each positive-fit element 24. It is evident from FIG. 1 that two receiving regions 32 can be provided on plugging side 10. Two receiving regions 32 can be disposed opposite one another perpendicular to plugging direction 18 and be disposed between the two positive-fit elements 24. Alternatively, the two positive-fit elements can be disposed between the two receiving regions.

Although receiving region 32 of connector housing 1 is strictly speaking not provided for positive-fit element 24 of connector housing 1, complementarity must nevertheless be present. Because receiving region 32 of connector housing 1 should fit together with positive-fit element 24′ of structurally identical mating housing 2. However, in order for receiving region 32 of connector housing 1 to be able to receive positive-fit element 24′ of mating housing 2, receiving region 32 of connector housing 1 must be complementary to structurally identical positive-fit element 24 on connector housing 1. In other words, the shaping of positive-fit element 24 of connector housing 1 transitively has an influence on the shape of receiving region 32 of connector housing 1.

Receiving region 32 configured to be complementary to positive-fit element 24 consequently forms a counterpart to positive-fit element 24. For example, at least one receiving region 32 can form at least in sections a negative form of at least one positive-fit element 24. The negative form is here an inverse form in which receiving region 32 captures projections of positive-fit element 24 as recesses and recesses of positive-fit element 24 as projections.

In view of the shaping of the positive-fit element already described as hook 26, prong 28 and/or rib 30, complementary receiving region 32 can be configured as a pocket 34 (see FIG. 1), groove 36 (see FIG. 7), channel 38 (see FIG. 8) or other type of recess that is sunk in transverse, in particular perpendicular to plugging direction 18.

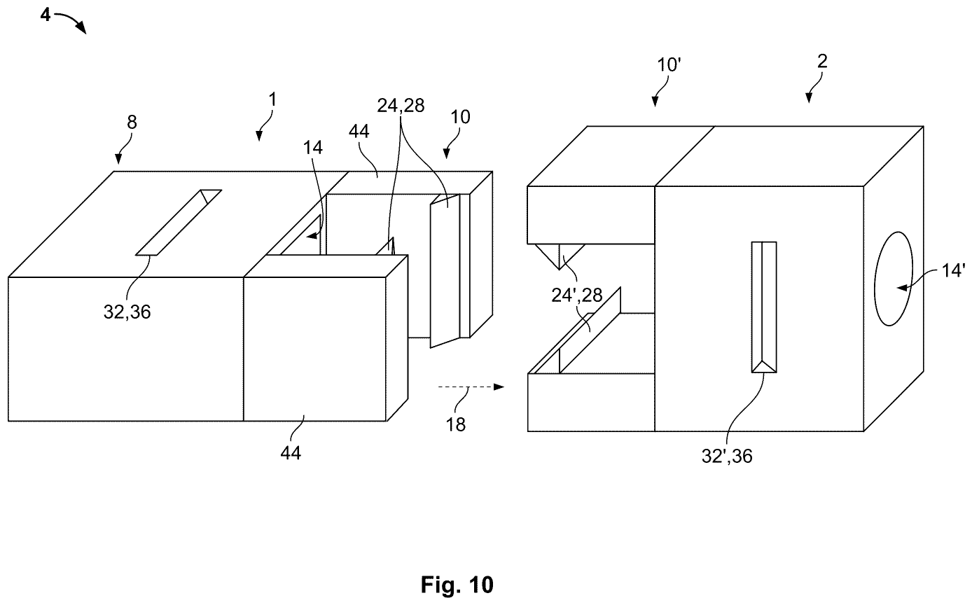

As shown in FIG. 7, receiving region 32 as a negative form can be mirrored at a mirror plane 40 relative to positive-fit element 24. Alternatively or additionally, receiving region 32 as a negative form can be rotated in a rotation plane 42 relative to positive-fit element 24. Mirror plane 40 and/or rotation plane 42 can there each run transverse to plugging direction 18, in particular perpendicular to plugging direction 18. In other words, positive-fit element 24 and its negative form that forms receiving region 32 can be mirror-inverted and/or rotated relative to one another. Correspondingly, connector housing 1 can then be pluggable with structurally identical mating housing 2 when connector housing 1 and mating housing 2 are oriented in a mirror-inverted manner and/or rotated relative to one another (see FIGS. 5 and 7 to 12).

Plugged state 20 is secured due to an interlocking of positive-fit element 24 of connector housing 1 with receiving region 32′ of mating housing 2 as well as of positive-fit element 24′ of mating housing 2 with receiving region 32 of connector housing 1 and a relative motion between connector housing 1 and mating housing 2 in plugging direction 18 is prevented.

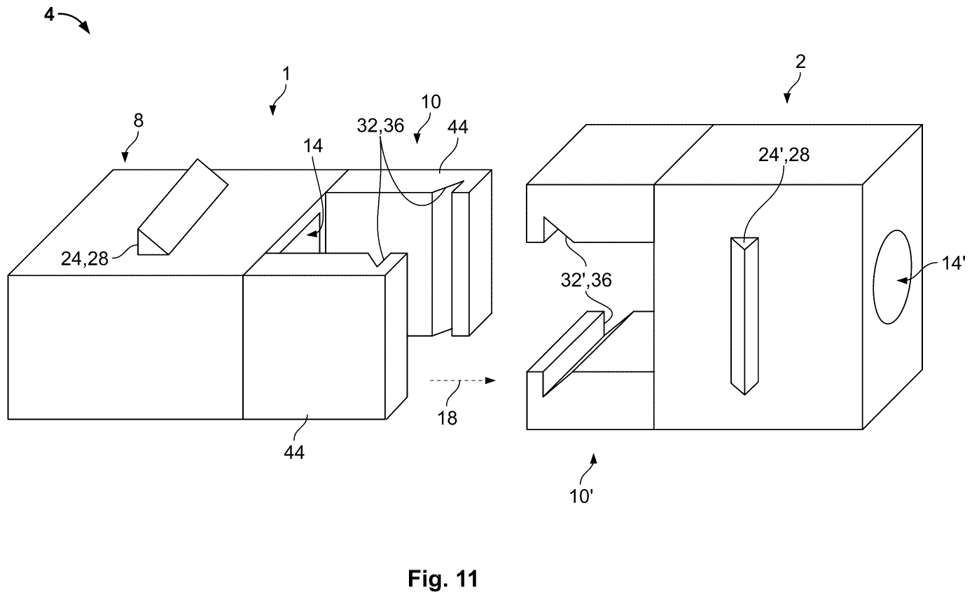

In order to achieve the deepest possible interlocking of connector housing 1 and mating housing 2, it is advisable to arrange at least one receiving region 32 between cable-side 8 and at least one positive-fit element 24 (see FIG. 2). In particular, receiving region 32 can be disposed in plugging direction 18 between cable-side 8 and positive-fit element 24. For mating housing 2, receiving region 32 of connector housing 1 is therefore disposed behind positive-fit element 24 of connector housing 1. However, it is evident from FIG. 11 that receiving region 32 of connector housing 1 can also be arranged forward of positive-fit element 24 of connector housing 1. In other words, positive-fit element 24 can likewise be disposed in plugging direction 18 between cable-side 8 and receiving region 32.

In order to release or unlock plugged state 20, the interlocking of positive-fit element 24 of connector housing 1 with receiving region 32′ of mating housing 2 and the interlocking of positive-fit element 24′ of mating housing 2 with receiving region 32 of connector housing 1 must be released. This unlocking is facilitated when at least one positive-fit element 24 is arranged on a deflectable snap arm 44. For example, snap arm 44 can be resiliently deflectable transverse to plugging direction 18, in particular perpendicular to plugging direction 18. Alternatively, snap arm 44 can be held to be pivotable by way of a hinge (not shown). Its own snap arm 44 can be provided for each positive-fit element 24 or multiple positive-fit elements can share a common snap arm. Of course, at least one receiving region 32 can also be arranged on snap arm 44 (see FIG. 11).

As shown in FIG. 1, snap arm 44 can be part of a rocker 46. Rocker 46 can comprise a first lever arm 48a extending away from cable-side 8 and a second lever arm 48b extending toward cable-side 8, wherein snap arm 44 forms first lever arm 48a. Disposed between first and second lever arms 48a, 48b of rocker 46 can be a notional axis of rotation 50 about which two lever arms 48a, 48b are pivotable. Its own rocker 46 can be provided for each snap arm 44.

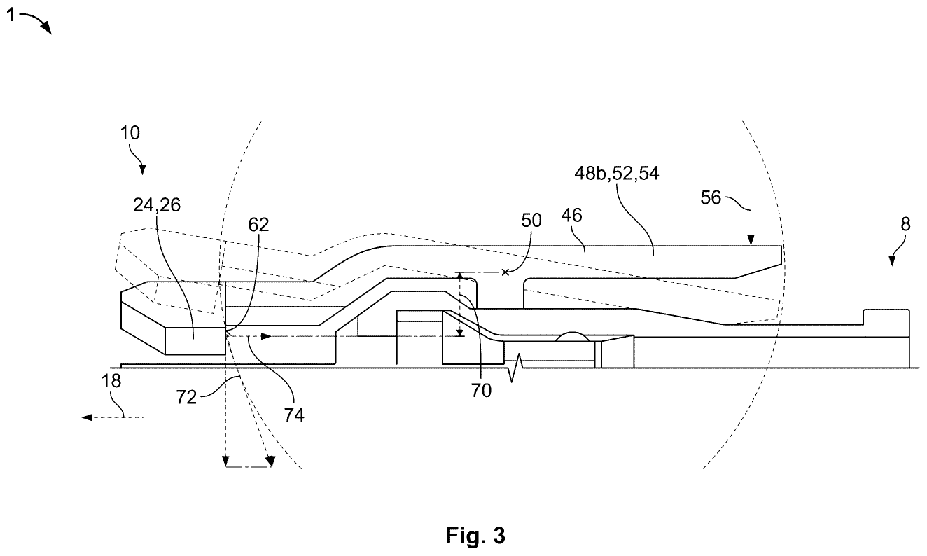

An actuating element 52 can be disposed on second lever arm 48b of rocker 46. Actuating element 52 and positive-fit element 24 are connected in a manner transmitting motion by way of rocker 46. Actuating element 52 can be, for example, a pressure region 54, The actuation of the pressure region 54 with a pressing force 56 perpendicular to plugging direction 18 leads to, for example, second lever arm 48b lowering and first lever arm 48a rising (see FIG. 3). This is equivalent to a deflection of snap arm 44 and causes positive-fit element 24 to move out of its engagement with receiving region 32′ of mating housing 2. When respective actuating element 52, 52′ is pressed on both connector housing 1 and mating housing 2, the housing assembly is unlocked.

In addition to unlocking, actuating element 52 can also support connector housing 1 and mating housing 2 being plugged together. Because the lowering of second lever arm 48b while simultaneously raising first lever arm 48a allows, for example, for positive-fit element 24 of connector housing 1 to move past associated receiving region 32′ of mating housing 2 in an unobstructed manner (and vice versa). When housing assembly 4 is plugged together completely, actuating element 52 can be released, whereby positive-fit element 24 sinks into associated receiving region 32′ and henceforth secures plugged state 20. In an analogous manner, actuating element 52′ at mating housing 2 can also support the plugging process.

Raising first lever arm 48a or the deflection of snap arm 44 can occur automatically during the plugging process when at least one insertion chamfer 58 is provided at connector housing 1. Its own insertion chamfer 58 can be present for each positive-fit element 24.

For example, positive-fit element 24′ of mating housing 2 disposed on snap arm 44 can travel onto insertion chamfer 58 of connector housing 1. It is then advisable to arrange insertion chamfer 58 of connector housing 1 in plugging direction 18 in alignment with receiving region 32 of connector housing 1. Positive-fit element 24′ of mating housing 2 can thereby engage directly in receiving region 32 of connector housing 1 under the effect of the resilient restoring force of snap arm 44 after insertion chamfer 58 is overcome.

As indicated in FIG. 7, at least one receiving region 32 can form an undercut 60 for at least one positive-fit element 24′ of mating housing 2. In particular, undercut 60 can be present as viewed in plugging direction 18, so that a motion of mating housing 2 in plugging direction 18 is prevented when positive-fit element 24′ of mating housing 2 engages in undercut 60.

Undercut 60 can there be formed by an abutment surface 62 pointing toward cable-side 8 which delimits at least one receiving region 32 at least in sections. For this purpose, abutment surface 62 can be spanned transverse to plugging direction 18, in particular perpendicular to plugging direction 18. Positive-fit element 24′ of mating housing 2 comes to abut against abutment surface 62, whereby a relative motion between connector housing 1 and mating housing 2 in plugging direction 18 is prevented and consequently their plugged state 20 is secured (see FIG. 6).

To release or unlock plugged state 20, positive-fit element 24′ of mating housing 2 can consequently be raised from abutment surface 62 of connector housing 1 and, vice versa, positive-fit element 24 of connector housing 1 can also be raised from abutment surface 62′ of mating housing 2.

As indicated in FIGS. 7 and 8, at least one positive-fit element 24 and at least one receiving region 32 can be arranged offset from one another, for example, in that a positional offset 64 and/or angular offset 66 exists therebetween. Consequently, a mutual obstruction of at least one positive-fit element 24 and at least one receiving region 32 can be avoided when being plugged together.

Alternatively, positive-fit element 24 of connector housing 1 can also be arranged in plugging direction 18 in alignment with receiving region 32 of connector housing 1 (see FIG. 2). In other words, at least one positive-fit element 24 and at least one receiving region 32 in connector housing 1 can overlap in plugging direction 18. In particular, at least one positive-fit element 24 can delimit at least one receiving region 32 at least in sections. As is evident from FIG. 1, two positive-fit elements 24 can jointly delimit two receiving regions 32.

This configuration is particularly advantageous since plugged housing assembly 4 can be unlocked by moving at least one positive-fit element 24 out of the associated receiving region 32′ at only a single housing (either connector housing 1 or mating housing 2). By moving positive-fit element 24 of connector housing 1 out, it leaves associated receiving region 32′ of mating housing 2. In the absence of positive-fit element 24 of connector housing 1, the delimitation of receiving region 32 of connector housing 1 is simultaneously removed, so that positive-fit element 24′ of mating housing 2 can also leave receiving region 32 of connector housing 1 in an unobstructed manner.

In order to implement this configuration, previously described abutment surface 62 (62′) can be located on at least one positive-fit element 24 (24′) in connector housing 1 (and consequently also in mating housing 2). In secured and plugged state 20, abutment surfaces 62, 62′ of connector housing 1 and mating housing 2 then abut against one another (see FIG. 6). If in this constellation, positive-fit element 24 of connector housing 1 is moved, it lifts off from abutment surface 62′ of mating housing 2, At the same time, abutment surface 62 of connector housing 1 also lifts off from positive-fit element 24′ of mating housing 2 without positive-fit element 24′ of mating housing 2 having to be moved for this purpose.

Based on FIGS. 2 and 3, it can be understood why it can be advantageous to have first lever arm 48a and second lever arm 48b of rocker 46 be arranged at least in sections at different distances from the remainder of connector housing 1. In other words, first lever arm 48a and second lever arm 48b can be disposed at different heights 68a, 68b in the force-free state of rocker 46 or be arranged at different heights measured perpendicular to plugging direction 18 (see FIG. 2).

For example, at least one positive-fit element 24 on first lever arm 48a can be disposed lower (i.e., closer to the remainder of connector housing 1) than second lever arm 48b with actuating element 52. In particular, first lever arm 48a can be disposed below axis of rotation 50 already mentioned, while second lever arm 48b is above or at the same height as axis of rotation 50. FIG. 3 shows how this height offset 70 advantageously leads to motion trajectory 72 of positive-fit element 24 having a pulling component 74 directed toward cable-side 8, with which connector housing 1 and its mating housing 2 are pulled toward one another. Any dimensional tolerances and unwanted play between connector housing 1 and mating housing 2 can thus be completely eliminated or at least be minimized.

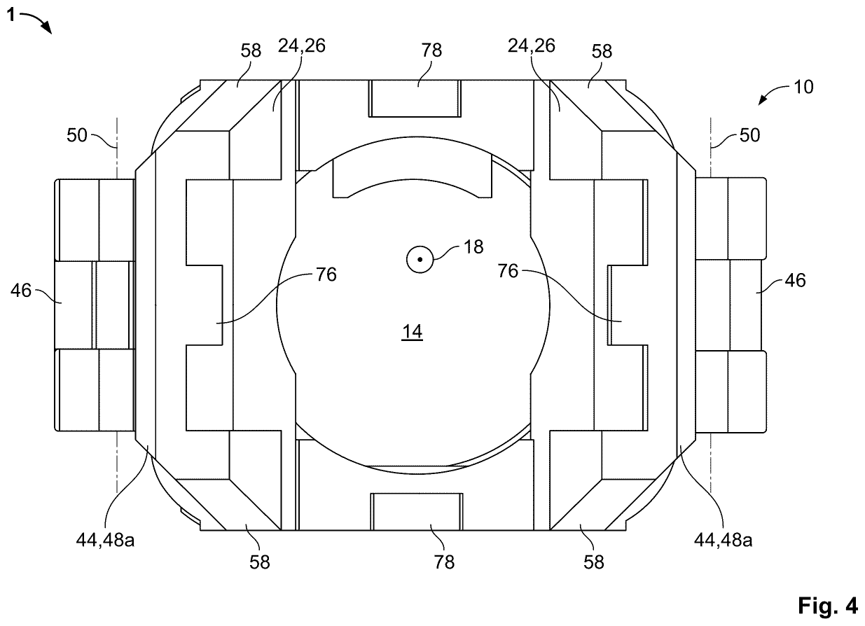

As is evident from FIG. 4, connector housing 1 comprise at least one coding projection 76 and at least one coding groove 78. For example, at least one coding projection 76 can be disposed on at least one positive-fit element 24 and at least one coding groove 78 in at least one receiving region 32. Of course, a reversed arrangement of coding projection and the coding groove is also conceivable. For each positive-fit element 24, its own coding groove 78 or coding projection 76, respectively, can be provided.

Structurally identical mating housing 2 also comprises at least one coding projection 76′ and at least one coding groove 78′ at corresponding positions (see FIG. 5). In plugged state 20, coding projection 76 of connector housing 1 meets coding groove 78′ of mating housing 2 and coding projection 76′ of mating housing 2 likewise meets coding groove 78 of connector housing 1. Consequently, despite the hermaphroditic configuration, a control function can nevertheless be performed through which incorrect plugging of connector housings and mating housings that do not belong to one another is avoided.

FIG. 6 shows plug connection 6 with housing assembly 4. Contact 16 is held in contact chamber 14 of connector housing 1. Mating housing 2 likewise comprises a contact chamber 14′ in which the mating contact is held. In plugged state 20, contact 16 and mating contact mutually contact one another, so that electrical currents and signals can be transmitted between cables 12 of plug connection 6.

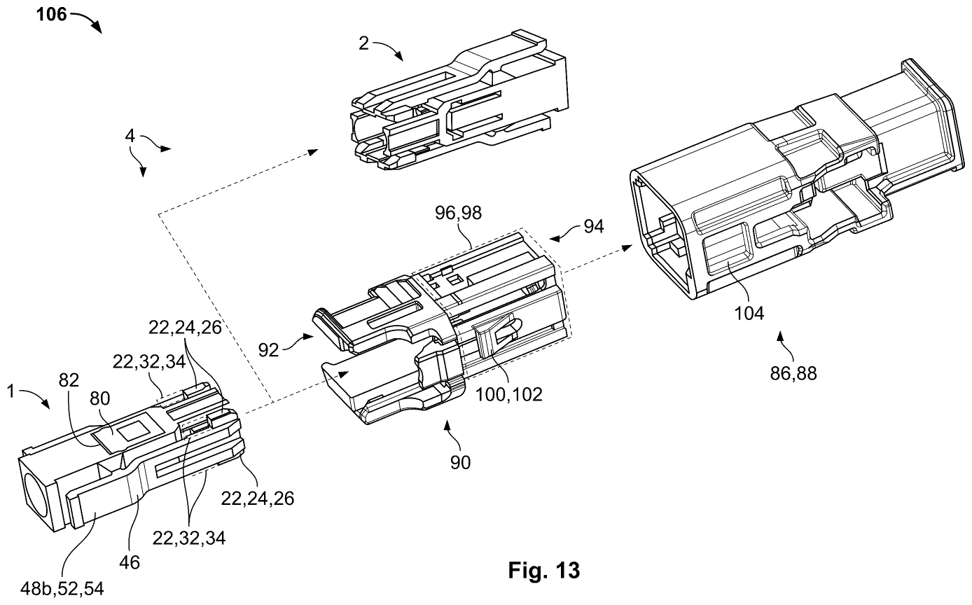

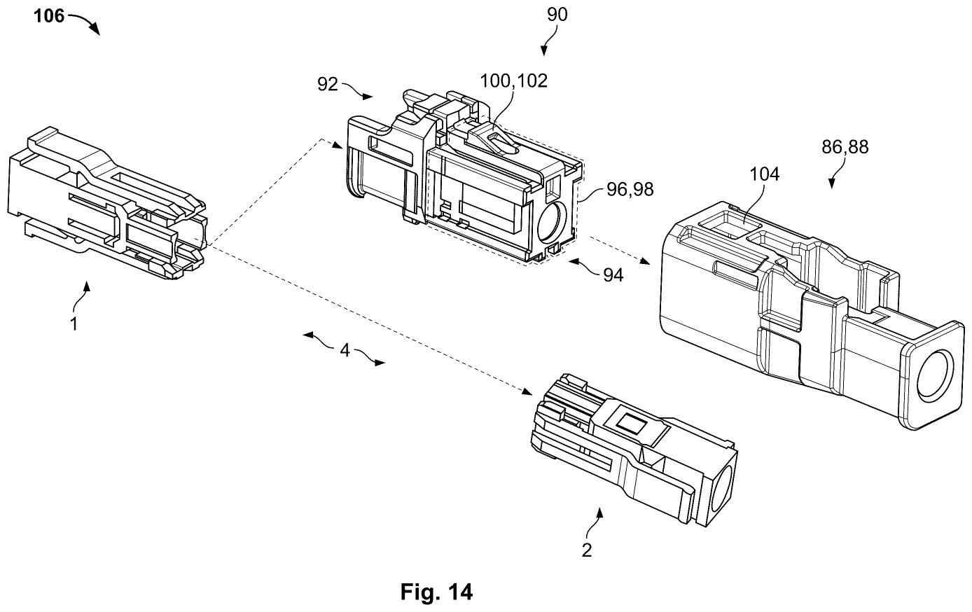

It is shown in FIG. 13 how connector housing 1, despite its hermaphroditic configuration, can be used along with a structurally identical mating housing 2 also in a conventional, non-hermaphroditic plug device 86. For example, backward compatibility of connector housing 1 with a socket housing 88 of a specified interface 86 that is already installed can be obtained in this way. For this purpose, an adapter 90 can be provided comprising an adapter inlet 92 and an adapter outlet 94. Adapter inlet 92 can be configured to receive connector housing 1 at least in part, while adapter outlet 94 forms a connector face 96 of specified interface 86 that is complementary to socket housing 88 (see FIG. 14). In other words, adapter outlet 94 can comprise an outer contour 98 which corresponds to the outer contour of a plug housing of specified interface 86.

Adapter 90 then functions as a connecting link between connector housing 1 and socket housing 88 of specified interface 86. Contact 16 is accessible to a mating contact (not shown) in socket housing 88 via adapter outlet 94.

In order to be able to reliably fulfill the function of the connecting link, adapter 90 can comprise an outer retaining element 100 at adapter outlet 94. In the configuration shown, outer retaining element 100 is configured as a latch protrusion 102. When adapter outlet 94 is plugged into socket housing 88 of specified interface 86, latch protrusion 102 engages, for example, in positive-fit manner in a latch opening 104 on socket housing 88. Likewise, adapter inlet 92 can comprise an inner retaining element which is in positive-fit engagement with connector housing 1. Alternatively or additionally, adapter 90 can also be held in a frictionally engaged or in a force-fitting manner (e.g., magnetically).

Adapter 90 shown in FIGS. 13 and 14 is part of an assembly kit 106 which furthermore also comprises housing assembly 4 and socket housing 88 of specified interface 86. As indicated by the dashed arrows, connector housing 1 can be plugged together with socket housing 88 with the addition of adapter 90. And by omitting adapter 90, connector housing 1 can be plugged together directly with mating housing 2, whereby assembly kit 106 gives connector housing 1 improved flexibility in application.

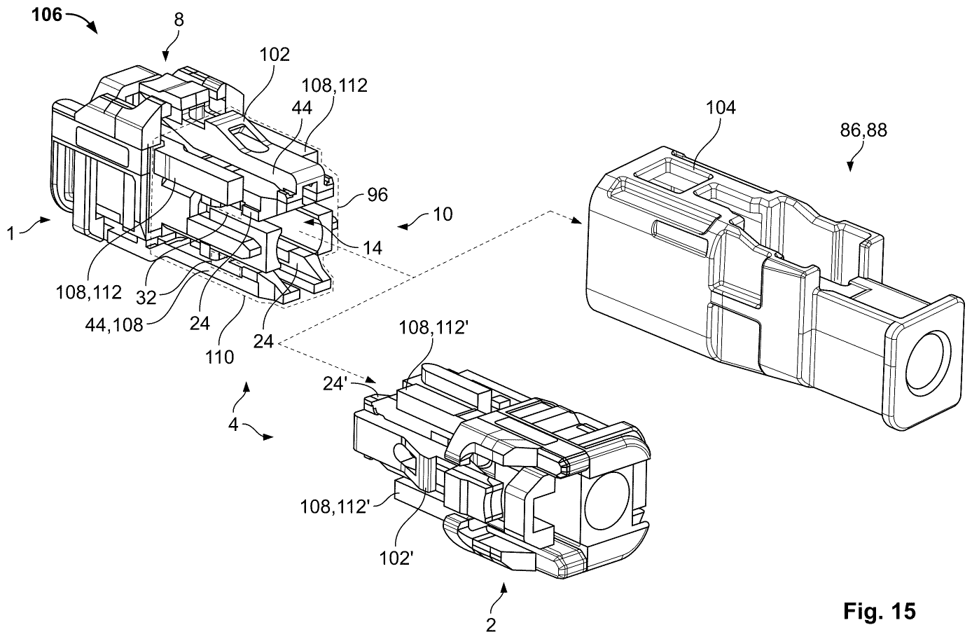

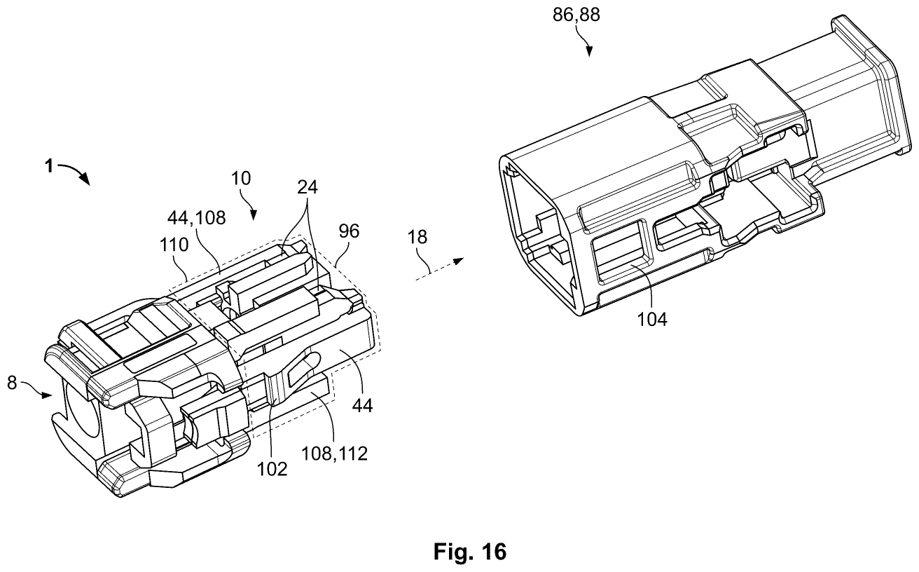

As shown by the alternative configuration from FIG. 15, connector housing 1 can also be configured to be compatible with socket housing 88 of specified interface 86 without an adapter 90, without losing the hermaphroditic property. For this purpose, latch protrusion 102 already mentioned can be arranged at connector housing 1. In other words, plugging side 10 of connector housing 1 can itself form connector face 96 that is complementary to socket housing 88 including latch protrusion 102. In particular, latch protrusion 102 can be arranged on plugging side 10 such that it is accessible for latch opening 104 of socket housing 88 (see FIG. 16), but blocks neither positive-fit elements 24, 24′ nor receiving regions 32, 32′ of connector housing 1 and mating housing 2.

For this purpose, latch protrusion 102 can be spaced from any positive-fit elements 24, 24′ and receiving regions 32, 32′. In the configuration shown in FIG. 15, latch protrusion 102 is arranged on snap arm 44 on the other side of positive-fit element 24 disposed there. This leads to latch protrusion 102 having to be moved toward contact chamber 14 to release the connection with socket housing 88, while positive-fit element 24 arranged on the other side must be moved away from contact chamber 14 when releasing from mating housing 2.

In order to support the plugging process with socket housing 88, connector housing 1 can optionally comprise one or more guide elements 108. Guide elements 108 can serve in particular to define connector face 96. Accordingly, connector housing 1 can be guided in a sliding manner with guide elements 108 into socket housing 88. For example, edges 110 of snap arm 44 can represent guide elements 108. Alternatively or additionally, further guide rails 112 can also be formed at connector housing 1 and serve as guide elements 108.

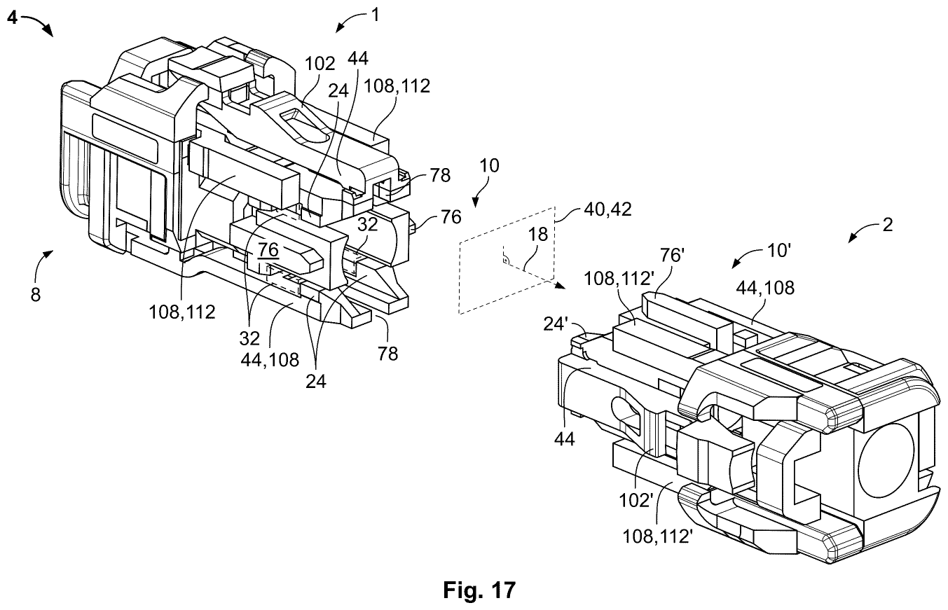

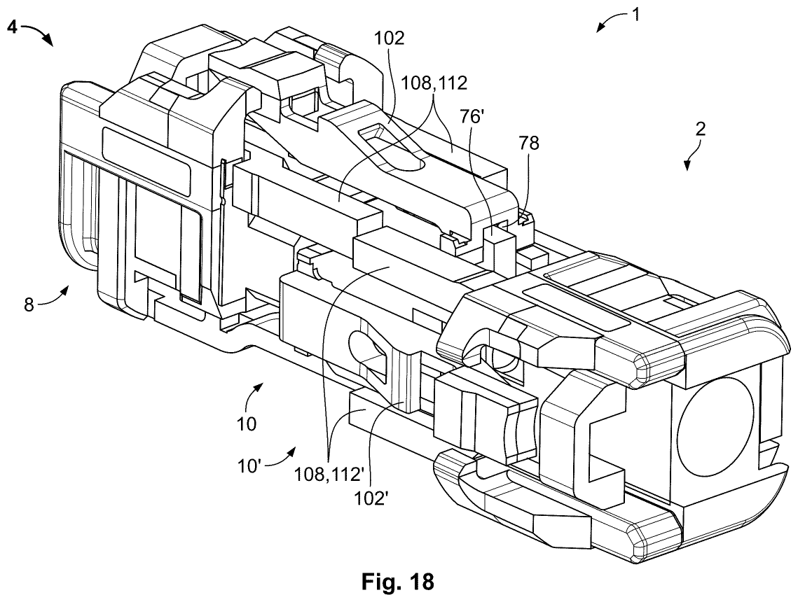

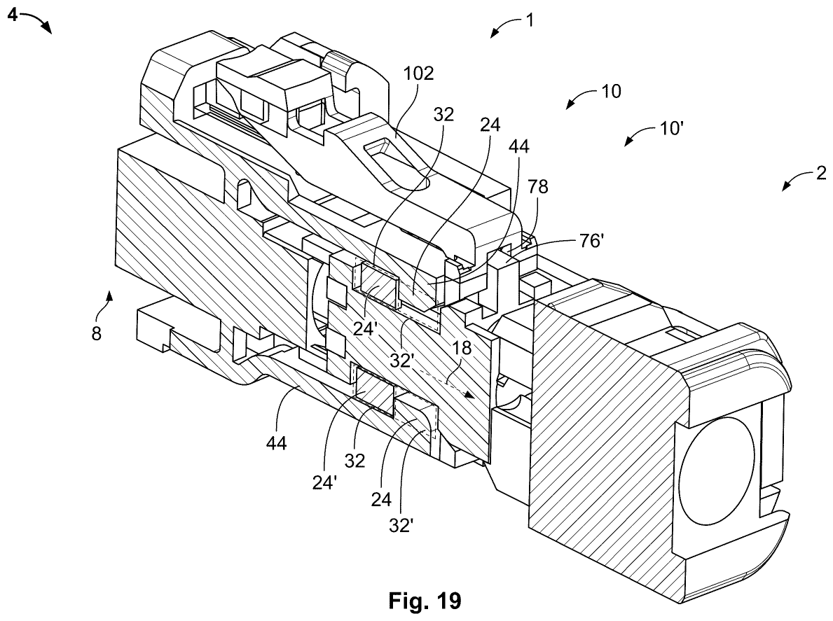

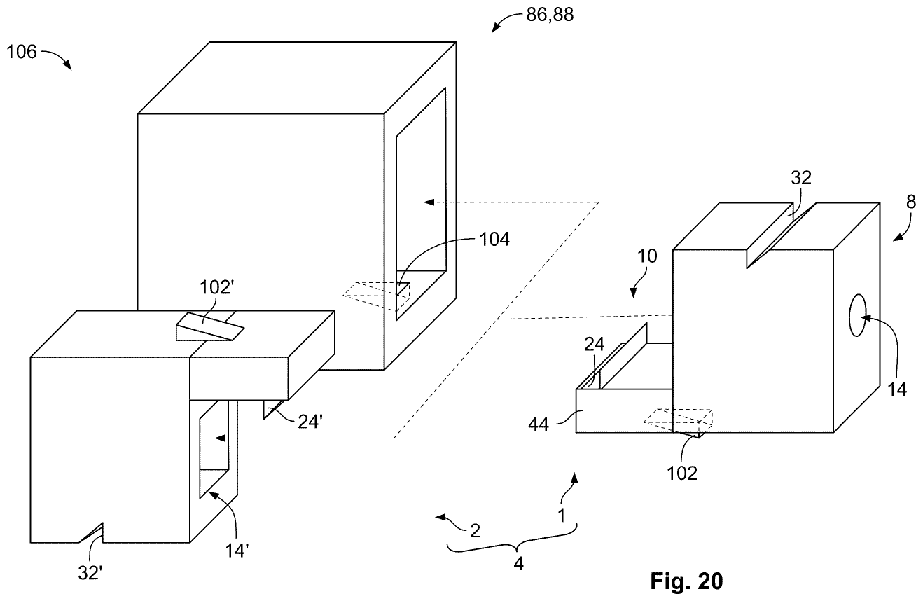

Since mating housing 2 also comprises a latch protrusion 102′ and guide rails 112′ due to the structural identity, it must furthermore be ensured that latch protrusions 102, 102′ and guide rails 112, 112′ of connector housing 1 and mating housing 2 do not mutually “get in each other's way.” For this purpose, it is advisable to configure connector housing 1 and mating housing 2 such that both must be oriented rotated relative to one another when being plugged together. In FIGS. 17 to 19, connector housing 1 and mating housing 2 are rotated in rotation plane 42 by 90° relative to one another. The plugging process then leads to associated positive-fit elements 24, 24′ and receiving regions 32′, 32 interlocking (see FIG. 19), while latch protrusions 102, 102′ and guide rails 112, 112′ stay away from one another (see FIG. 18). The alternative configuration from FIG. 20 evidences that a rotation by 180° is also possible to realize the simultaneous compatibility between connector housing 1 and mating housing 2 as well as connector housing 1 and socket housing 88.

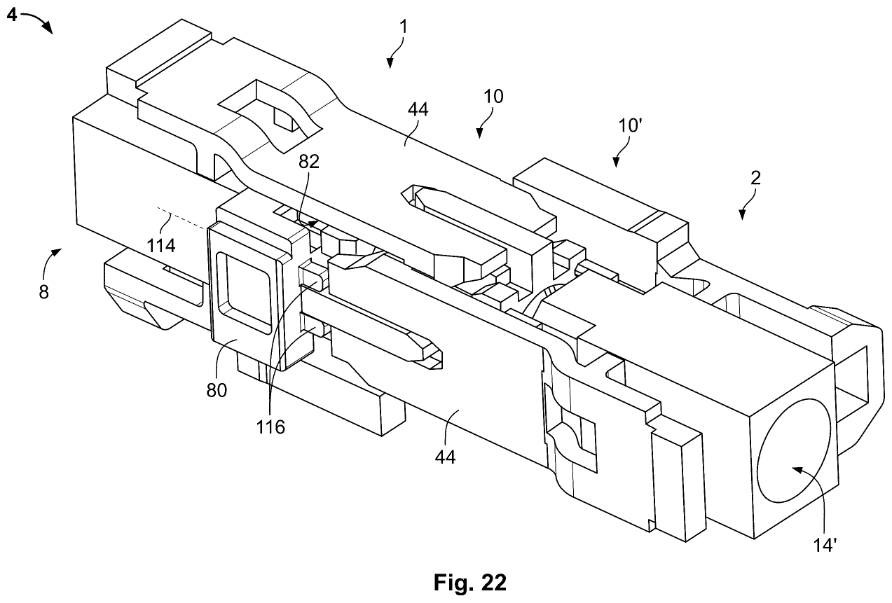

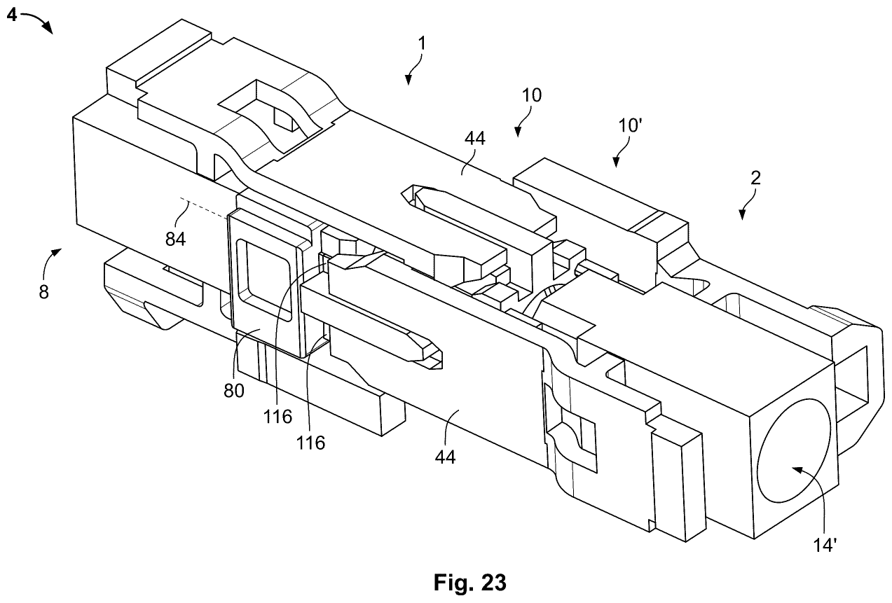

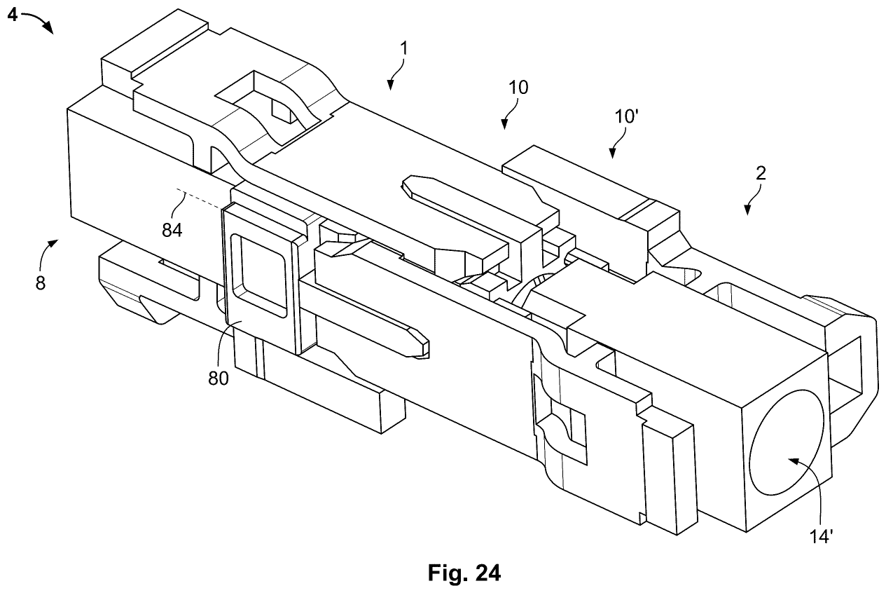

A further function of terminal lock 80 shall be explained based on FIGS. 21 to 24. Terminal lock 80 can there be used to prevent a premature plugging together of connector housing 1 and mating housing 2. In addition to final position 84 already mentioned (see FIGS. 23 and 24), a control position 114 (see FIG. 22) can comprise a terminal lock 80 for this purpose. In control position 114, terminal lock 80 is not received entirely in its insertion slot 82, but protrudes in part. In particular, terminal lock 80 can comprise one or more control projections 116 which in the control position 114 point toward mating housing 2 and prevent it from being plugging together.

Only when terminal lock 80 is made to move from control position 114 to final position 84 (e.g., by assembly personnel who thereby acknowledge the installation of contact 16 into contact chamber 14) do control projections 116 move out of the way of mating housing 2 (see FIG. 23). With terminal lock 80 in final position 84, connector housing 1 and mating housing 2 can then be completely plugged together (see FIG. 24).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A connector housing for a plug connection, the connector housing comprising:
a cable side; and
a plugging side, said plugging side including at least one positive-fit element extending transverse to said plugging direction, and said plugging side including at least one receiving region which is complementary, at least in sections, to said at least one positive-fit element;
wherein said plugging side is configured to be connectable along a plugging direction with a mating housing that is structurally identical to said plugging side of the connector housing.

2. The connector housing according to claim 1, wherein said at least one receiving region forms, at least in sections, a negative form of said at least one positive-fit element which is mirrored at a mirror plane and/or rotated in a rotation plane.

3. The connector housing according to claim 1, wherein said at least one receiving region is located between said cable side and said at least one positive-fit element.

4. The connector housing according to claim 1, wherein said at least one receiving region is delimited at least in sections by an abutment surface facing toward said cable side.

5. The connector housing according to claim 1, wherein said at least one positive-fit element delimits said at least one receiving region at least in sections.

6. The connector housing according to claim 1, wherein said at least one positive-fit element is in alignment at least in sections with said at least one receiving region, or said at least one positive-fit element and said at least one receiving region are offset from one another.

7. The connector housing according to claim 1, wherein said at least one receiving region forms an undercut for said at least one positive-fit element.

8. The connector housing according to claim 1, wherein said at least one positive-fit element is arranged on a deflectable snap arm.

9. The connector housing according to claim 1, wherein said connector housing comprises at least one rocker having a first lever arm extending away from said cable side and a second lever arm extending toward said cable side, wherein said at least one positive-fit element is arranged on said first lever arm of said rocker, and wherein an actuating element is disposed on said second lever arm of said rocker.

10. The connector housing according to claim 9, wherein said first lever arm and said second lever arm of said rocker are disposed at least in sections at different heights.

11. The connector housing according to claim 1, wherein said connector housing comprises at least one coding projection and at least one coding groove, wherein said at least one coding projection is disposed on said at least one positive-fit element, and wherein said at least one coding groove is disposed in said at least one receiving region.

12. The connector housing according to claim 1, wherein said plugging side comprises two positive-fit elements and two receiving regions, wherein said two positive-fit elements are disposed opposite one another perpendicular to said plugging direction, and wherein said two receiving regions are disposed opposite one another perpendicular to said plugging direction.

13. The connector housing according to claim 12, wherein said two positive-fit elements jointly delimit said two receiving regions.

14. A housing assembly comprising:
a connector housing including a cable side and a plugging side, said plugging side of the connector housing including at least one positive-fit element extending transverse to a plugging direction, and said plugging side of the connector housing including at least one receiving region which is complementary, at least in sections, to said at least one positive-fit element;
a mating housing that is structurally identical to the connector housing, the mating housing including a cable side and a plugging side, said plugging side of the mating housing including at least one positive-fit element extending transverse to the plugging direction, and said plugging side of the mating housing including at least one receiving region which is complementary, at least in sections, to said at least one positive-fit element;
wherein said plugging side of the connector housing is plugged together with said plugging side of the mating housing along the plugging direction.

15. The housing assembly according to claim 14, further comprising at least one pair of contacts, wherein a first contact of said pair of contacts is held in said connector housing, and wherein a second contact of said pair of contacts is held in said mating housing.

16. The housing assembly according to claim 14, further comprising:
a socket housing of a specified interface; and
an adapter including an adapter inlet and an adapter outlet, wherein said adapter inlet is configured to receive said connector housing at least in part, and wherein said adapter outlet forms a connector face of said specified interface that is complementary to said socket housing.

17. The housing assembly according to claim 14, further comprising:
a socket housing of a specified interface;
wherein said plugging side of said connector housing of said housing assembly forms a connector face of said specified interface that is complementary to said socket housing.
